(19) United States
(12) Patent Application Publication
(10) Pub. No.: US 2026/0005493 A1
(43) Pub. Date: Jan. 1, 2026

(54) SPARK PLUG

(71) Applicant: Niterra Co., Ltd., Nagoya-shi (JP)

(72) Inventors: Naoyuki MUKOYAMA, Nagoya-shi (JP); Tatsuya GOZAWA, Nagoya-shi (JP); Kento KUBOTA, Nagoya-shi (JP); Kenji BAN, Nagoya-shi (JP); Natsuki KURIMOTO, Nagoya-shi (JP); Koji KIRIYAMA, Nagoya-shi (JP)

(73) Assignee: Niterra Co., Ltd., Nagoya-shi (JP)

(21) Appl. No.: 19/243,928

(22) Filed: Jun. 20, 2025

(30) Foreign Application Priority Data
Jun. 28, 2024 (JP) 2024-104893
Apr. 23, 2025 (JP) 2025-071095

(51) Int. Cl. H01T 13/34; H01T 13/39

(52) U.S. Cl. CPC H01T 13/34; H01T 13/39

(57) ABSTRACT

A spark plug includes an insulator including a step portion; a center electrode, and a metal shell being disposed around an outer periphery of the insulator and including an inner peripheral surface. The metal shell includes a threaded portion; a seating portion including a seating surface provided on the rear-end side of the threaded portion; and a retaining portion provided on the inner peripheral surface, the retaining portion retaining the step portion. The spark plug satisfies V/(R²·L)≤0.0170, where V (mm³) is a capacity of a space that is located on the front-end side of the retaining portion and inside the inner peripheral surface including the retaining portion and that excludes the center electrode and the insulator, R (mm) is an outer diameter of the threaded portion, and L (mm) is a distance from a front end of the metal shell to the seating surface.

### RELATED APPLICATIONS

This application claims priority to Japanese Application No. 2024-104893, filed Jun. 28, 2024, and Japanese Application No. 2025-071095, filed Apr. 23, 2025, each of which is hereby incorporated by reference in its entirety.

### FIELD OF THE INVENTION

The present invention relates to a spark plug.

### BACKGROUND OF THE INVENTION

A known spark plug includes an insulator in which a center electrode is disposed and a metal shell disposed around an outer periphery of the insulator. Japanese Unexamined Patent Application Publication No. 2013-55022 describes a technology for preventing pre-ignition caused when the insulator is overheated and serves as an ignition source by setting the volume of a space between an inner peripheral surface of the metal shell and an outer peripheral surface of the insulator within a predetermined range.

### SUMMARY OF THE INVENTION

There is a demand for a technology for reducing the occurrence of pre-ignition as in the related art.

The present invention has been made to meet the demand, and an object of the present invention is to provide a spark plug capable of reducing the occurrence of pre-ignition.

To achieve the above-described object, a spark plug according to a first aspect includes an insulator having an axial hole extending from a front-end side toward a rear-end side along an axial line, the insulator including a step portion having an outer diameter decreasing from the rear-end side toward the front-end side; a center electrode disposed in the axial hole; and a metal shell having a cylindrical shape, the metal shell being disposed around an outer periphery of the insulator and including an inner peripheral surface. The metal shell includes a threaded portion including an external thread; a seating portion including a seating surface provided on the rear-end side of the threaded portion; and a retaining portion provided on the inner peripheral surface, the retaining portion retaining the step portion. The spark plug satisfies V/(R²·L)≤0.0170, where V (mm³) is a capacity of a space that is located on the front-end side of the retaining portion and inside the inner peripheral surface including the retaining portion and that excludes the center electrode and the insulator, R (mm) is an outer diameter of the threaded portion, and L (mm) is a distance from a front end of the metal shell to the seating surface.

According to a second aspect, in the first aspect, in a cross section including the axial line, the insulator has no projecting portion on an outer peripheral surface of the insulator in a region that is between an outside corner at a front end of the insulator and an inside corner adjacent to and on the front-end side of the step portion and that faces the inner peripheral surface of the metal shell. The projecting portion is a rounded outside corner with a radius of 1 mm or less.

According to a third aspect, in the first or second aspect, the spark plug further includes a ground electrode connected to the metal shell. The ground electrode contains Ni or Pt as a main component.

According to a fourth aspect, in any one of the first to third aspects, the spark plug satisfies 1.90≤S/V, where S (mm²) is an area in which the metal shell is in contact with the space.

According to the present invention, the capacity V (mm³) of the space that is located

on the front-end side of the retaining portion and inside the inner peripheral surface of the metal shell including the retaining portion and that excludes the center electrode and the insulator, the outer diameter R (mm) of the threaded portion, and the distance L (mm) from the front end of the metal shell to the seating surface satisfy V/(R²·L)≤0.0170. By focusing on the relationship between the capacity of the space that the combustion gas enters and the volume of a portion that transmits the heat of the combustion gas to the engine, the relationship between the heat received by the spark plug from the combustion gas and the heat released from the spark plug can be appropriately set. Therefore, the occurrence of pre-ignition can be reduced.

### BRIEF DESCRIPTION OF THE DRAWINGS

FIG. 1 is a half sectional view of a spark plug according to a first embodiment;

FIG. 2 is an enlarged sectional view of a part of the spark plug;

FIG. 3 is a half sectional view of a spark plug according to a second embodiment;

FIG. 4 is an enlarged sectional view of a part of the spark plug;

FIG. 5 is a half sectional view of a spark plug according to a third embodiment;

FIG. 6 is an enlarged sectional view of a part of the spark plug;

FIG. 7 is a half sectional view of a spark plug according to a fourth embodiment; and

FIG. 8 is an enlarged sectional view of a part of the spark plug.

### DETAILED DESCRIPTION OF THE INVENTION

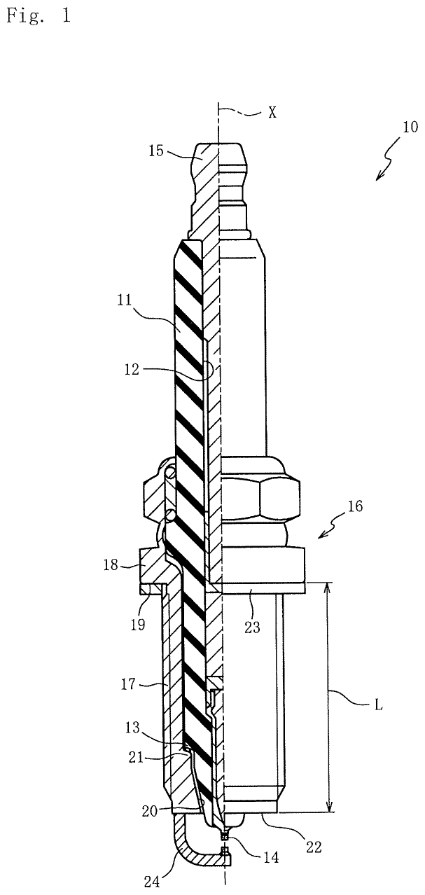

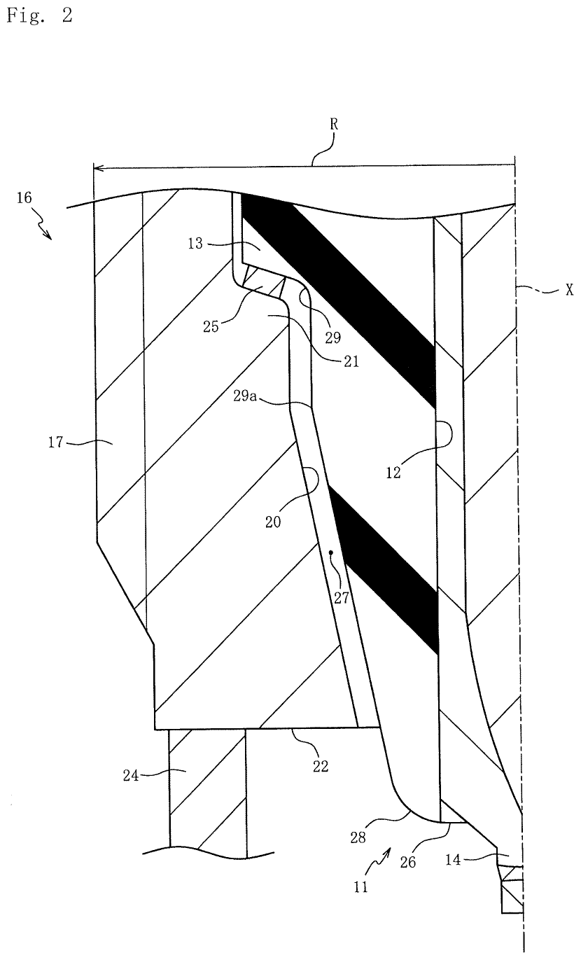

Preferred embodiments of the present invention will now be described with reference to the accompanying drawings. FIG. 1 is a half sectional view of a spark plug 10 according to a first embodiment with an axial line X at the boundary. The bottom of FIG. 1 will be referred to as a front-end side of the spark plug 10, and the top of FIG. 1 will be referred to as a rear-end side of the spark plug 10 (this also applies to FIGS. 2 to 6). The spark plug 10 includes an insulator 11, a center electrode 14, and a metal shell 16.

The insulator 11 is a substantially cylindrical member made of a ceramic, such as alumina, having good mechanical properties and insulating properties at high temperatures. The insulator 11 has an axial hole 12 extending along the axial line X and includes a step portion 13 having an outer diameter decreasing from the rear-end side toward the front-end side.

The center electrode 14 is disposed in a front region of the axial hole 12 in the insulator 11. The center electrode 14 is a rod-shaped conductor including a highly thermally conductive core material embedded in a base material. The base material may be made of, for example, a metal, such as a Ni-based alloy or Ni. The core material may be made of, for example, copper or an alloy containing copper as the main component. The core material may be omitted. The center electrode 14 may be provided with a tip located at the front end of the center electrode 14 and made mainly of a precious metal, such as Pt, Ir, or Ru. The tip may be omitted.

The center electrode 14 is electrically connected to a metal terminal 15 in the axial hole 12. The metal terminal 15 is a rod-shaped member to be connected to an ignition system (not illustrated), and is made of a conductive metal material (for example, low-carbon steel).

The metal shell 16 is a substantially cylindrical member made of a conductive metal material (for example, low-carbon steel). The metal shell 16 includes a threaded portion 17 that engages with an internal thread in a plug hole in an engine (not illustrated), and a seating portion 18 provided on the rear-end side of the threaded portion 17 and having a seating surface 19. A gasket 23 is disposed between the threaded portion 17 and the seating portion 18.

The threaded portion 17 has an external thread. When the threaded portion 17 is screwed into the plug hole and the seating surface 19 is pressed against the engine with the gasket 23 disposed therebetween, an axial tension is applied to the threaded portion 17. The metal shell 16 has an inner peripheral surface 20 including a retaining portion 21 located on the front-end side of the step portion 13 of the insulator 11 to retain the step portion 13. The distance from a front end 22 of the metal shell 16 to the seating surface 19 is L (mm).

A ground electrode 24 is a rod-shaped conductor connected to the metal shell 16. The ground electrode 24 includes a highly thermally conductive core material embedded in a base material. The base material may be made of, for example, a Ni-based alloy. The core material may be made of, for example, copper or an alloy containing copper as the main component. The main component (element with the highest content) of the base material of the ground electrode 24 is Ni. The core material may be omitted. The ground electrode 24 is provided with a tip located at an end of the ground electrode 24 and made mainly of a precious metal, such as Pt, Ir, or Ru. The tip may be omitted. A spark gap is provided between the ground electrode 24 and the center electrode 14.

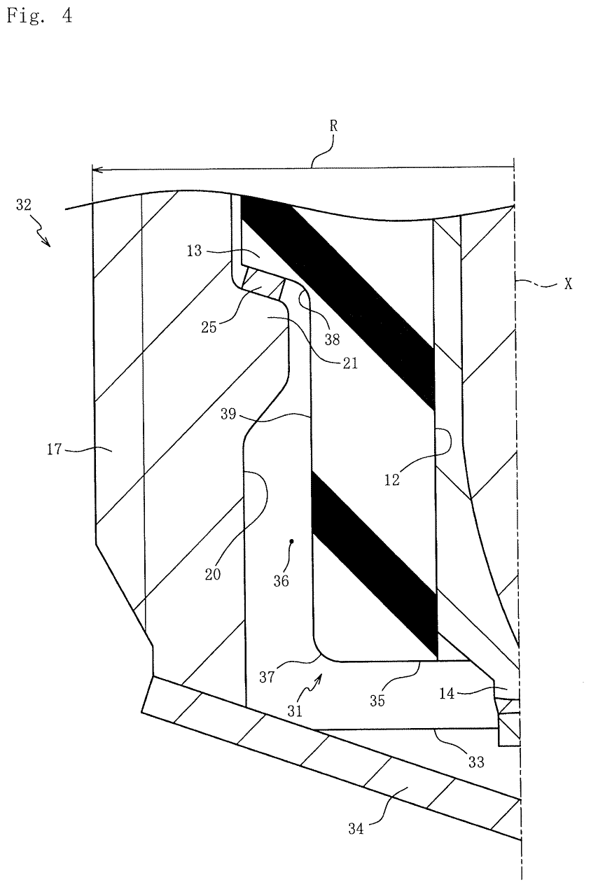

FIG. 2 is an enlarged sectional view of a part of the spark plug 10 including the axial line X. FIG. 2 illustrates a region on one side of the axial line X, and a region on the other side is omitted (this also applies to FIGS. 4, 6, and 8). An inner gasket 25 is interposed between the step portion 13 of the insulator 11 and the metal shell 16 to prevent leakage of gas in a combustion chamber of the engine (not illustrated). The inner gasket 25 is a part of the retaining portion 21. The inner gasket 25 is an annular plate member. The material of the inner gasket 25 may be, for example, a metal, such as iron or steel, that is softer than the metal material of the metal shell 16.

The insulator 11 has a front end 26 located on the front-end side of the front end 22 of the metal shell 16. The center electrode 14 projects from the front end 26 of the insulator 11 toward the front-end side. A cylindrical space 27 is formed inside the inner peripheral surface 20 of the metal shell 16. The space 27 is defined by the insulator 11 and the inner gasket 25. The space 27 has a capacity V (mm³) equal to the volume of a rotating body obtained by rotating, around the axial line X, an area (mm²) of the space 27 having an outline defined by the inner peripheral surface 20 of the metal shell 16 (including an inner peripheral surface of the inner gasket 25), an outer peripheral surface of the insulator 11, and the perpendicular from the front end 22 of the metal shell 16 to the axial line X in the cross section including the axial line X.

The outer peripheral surface of the insulator 11 includes a projecting portion 29a in a region that is between an outside corner 28 at the front end 26 of the insulator 11 and an inside corner 29 adjacent to and on the front-end side of the step portion 13, and that faces the inner peripheral surface 20 of the metal shell 16. The outside corner 28 and the inside corner 29 are rounded in the present embodiment, but are not limited to this. The outside corner 28 and the inside corner 29 may, of course, be formed without being chamfered or rounded. Similarly, the projecting portion 29a may be rounded or chamfered.

The projecting portion 29a is a rounded outside corner with a radius of 1 mm or less. When the projecting portion 29a has an angled corner surface formed by chamfering, the projecting portion 29a is an outside corner for which an imaginary arc smoothly connecting the ends of the angled corner surface has a radius of 1 mm or less. The radius of the outside corner of the projecting portion 29a in the cross section of the insulator 11 including the axial line X can be measured by using an image measuring device or a projector.

The spark plug 10 ignites fuel supplied to the combustion chamber of the engine (not illustrated), and a part of high-temperature combustion gas generated as a result of the combustion of the fuel enters the space 27. The combustion gas that has entered the space 27 heats the insulator 11, the metal shell 16, and the inner gasket 25. As the capacity V of the space 27 increases, the volume of the combustion gas that enters the space 27 also increases, resulting in an increased amount of heat being transmitted from the combustion gas to the insulator 11, the metal shell 16, and the inner gasket 25.

The outer diameter (diameter) of the threaded portion 17 is R (mm). The outer diameter R is the nominal diameter specified in JIS B 0205-4:2001. The outer diameter R (mm) of the threaded portion 17, the distance L (mm) between the front end 22 of the metal shell 16 and the seating surface 19 (see FIG. 1), and the capacity V (mm³) of the space 27 satisfy V/(R²·L)≤0.0170. Here, R²·L is proportional to the volume of a portion that transmits the heat of the combustion gas to the engine. By focusing on the relationship between the capacity V of the space 27 that the combustion gas enters and the volume of the portion that transmits the heat of the combustion gas to the engine, heat received by the spark plug 10 from the combustion gas can be released from the spark plug 10 to the engine through the threaded portion 17, so that the occurrence of pre-ignition with the insulator 11, the metal shell 16, and other components serving as an ignition source can be reduced.

The capacity V (mm³), the outer diameter R (mm), and the distance L (mm) preferably satisfy 0.0010≤V/(R²·L). This is because when the space 27 has at least a certain size, sufficient scavenging performance can be obtained and overheated particles are less likely to remain in the space 27, so that the occurrence of pre-ignition caused by unburnt residues can be reduced.

When the area in which the metal shell 16 is in contact with the space 27 is S (mm²), the spark plug 10 preferably satisfies 1.90≤S/V. This is because as the area S of the metal shell 16 increases, the combustion gas that has entered the space 27 is more easily cooled by the metal shell 16, so that the heat accumulated in the spark plug 10 is reduced and that the occurrence of pre-ignition can be further reduced.

The area S is equal to the area of a cylindrical surface obtained by rotating, around the axial line X, the distance over which the inner peripheral surface 20 of the metal shell 16 extends between the front end of the inner gasket 25 and the front end 22 of the metal shell 16. The area S can be increased by increasing the diameter of a portion of the inner peripheral surface 20 of the metal shell 16 that is in contact with the space 27. The capacity V can be prevented from being excessively increased by increasing the thickness of a portion of the insulator 11 that is in contact with the space 27 in accordance with an increase in the diameter of the inner peripheral surface 20. Thus, both V/(R²·L)≤0.0170 and 1.90≤S/V can be satisfied.

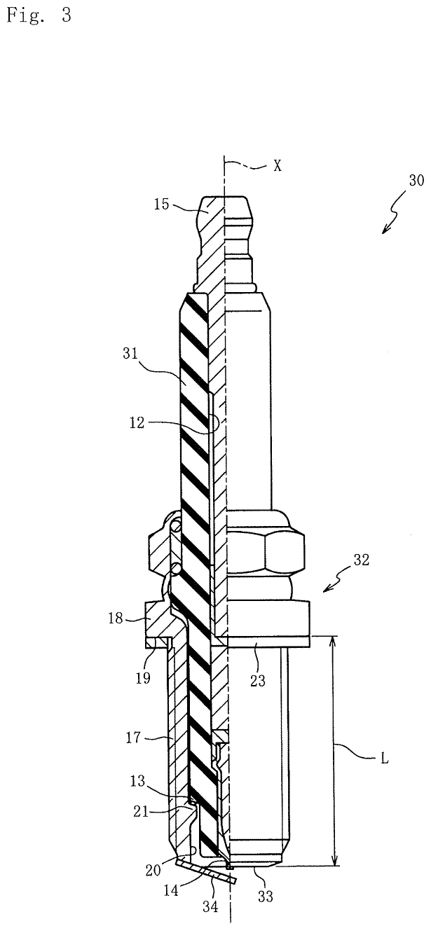

A second embodiment will be described with reference to FIGS. 3 and 4. In the spark plug 10 of the first embodiment described above, the front end 26 of the insulator 11 is located on the front-end side of the front end 22 of the metal shell 16. In contrast, in a spark plug 30 of the second embodiment described below, a front end 35 of an insulator 31 is located on the rear-end side of a front end 33 of a metal shell 32. In the second embodiment, elements that are the same as those described in the first embodiment are denoted by the same reference signs, and the following description is partially omitted.

FIG. 3 is a half sectional view of the spark plug 30 according to the second embodiment. The spark plug 30 includes the insulator 31, the center electrode 14, and the metal shell 32. The distance from the front end 33 of the metal shell 32 to the seating surface 19 is L (mm). A spark gap is provided between a rod-shaped ground electrode 34 connected to the metal shell 32 and the center electrode 14. The main component of the ground electrode 34 is Pt.

FIG. 4 is an enlarged sectional view of a part of the spark plug 30 including the axial line X. The front end 35 of the insulator 31 is located on the rear-end side of the front end 33 of the metal shell 32. The center electrode 14 projects from the front end 33 of the metal shell 32 toward the front-end side. A space 36 located inside the inner peripheral surface 20 of the metal shell 32, excluding the center electrode 14 and the insulator 31, and defined by the inner gasket 25 has a capacity V (mm³). The capacity V (mm³), the outer diameter R (mm) of the threaded portion 17, and the distance L (mm) satisfy V/(R²·L)≤0.0170. Thus, the occurrence of pre-ignition can be reduced.

The spark plug 30 is structured such that a portion of the ground electrode 34 is disposed in the space 36. The volume of the portion of the ground electrode 34 in the space 36 is subtracted from the capacity V of the space 36. The capacity V of the space 36 is equal to the volume determined by subtracting an overlapping volume of the ground electrode 34 from the volume of a rotating body obtained by rotating, around the axial line X, an area (mm²) of the space 36 having an outline defined by the inner peripheral surface 20 of the metal shell 32 (including an inner peripheral surface of the inner gasket 25), an outer peripheral surface and the front end 35 of the insulator 31, the center electrode 14, and the perpendicular from the front end 33 of the metal shell 32 to the axial line X. The volume of the ground electrode 34 in the space 36 (overlapping volume of the ground electrode 34) is determined by multiplying the area of a region (triangular region) in which the ground electrode 34 and the space 36 overlap in the cross section including the axial line X by the width of the ground electrode 34 (volume of a triangular prism).

The outer peripheral surface of the insulator 31 has no projecting portion with a rounded corner having a radius of 1 mm or less in a region 39 that is between an outside corner 37 at the front end 35 of the insulator 31 and an inside corner 38 adjacent to and on the front-end side of the step portion 13, and that faces the inner peripheral surface 20 of the metal shell 32. Since the region 39 has a substantially constant electrical field intensity, the occurrence of discharge (side spark) between the region 39 and the metal shell 32 can be reduced. Although the region 39 is parallel to the axial line X in the present embodiment, the region 39 is not limited to this. The region 39 may, of course, be at an angle relative to the axial line X or curved.

The spark plug 30 preferably also satisfies 0.0010≤V/(R²·L). In addition, when the area in which the metal shell 32 is in contact with the space 36 is S (mm²), the spark plug 30 preferably satisfies 1.90≤S/V. This is because the occurrence of pre-ignition can be further reduced.

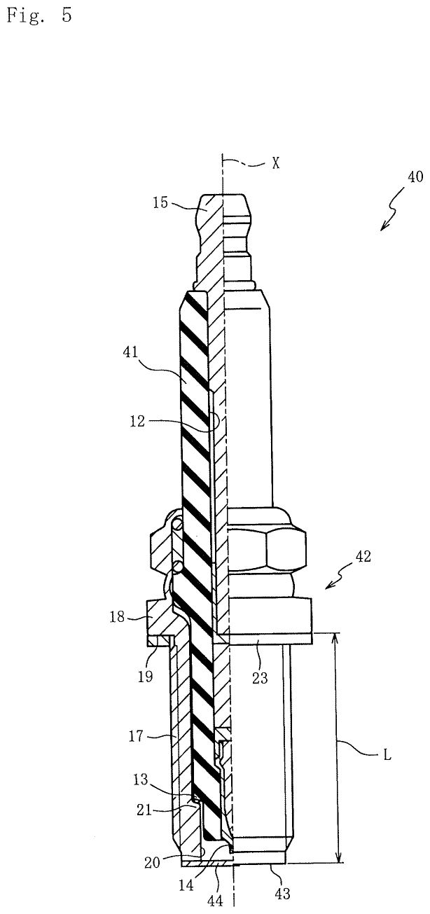

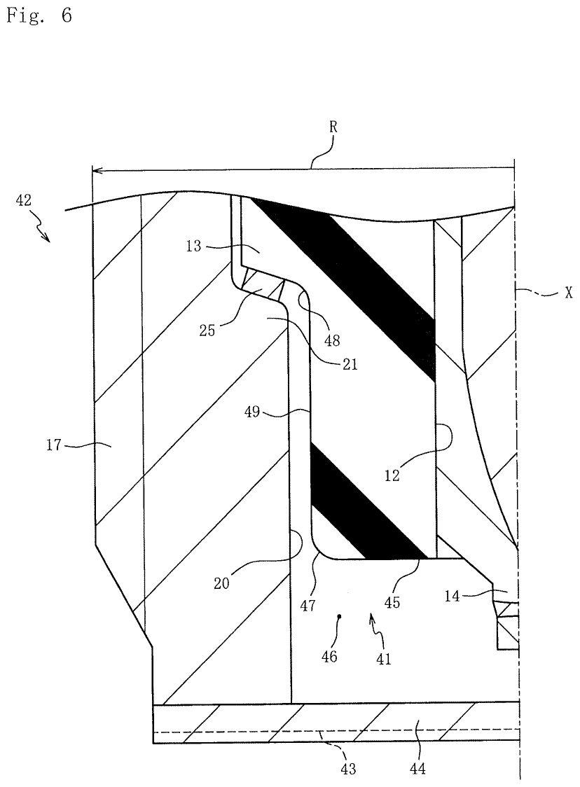

A third embodiment will be described with reference to FIGS. 5 and 6. In the spark plug 30 of the second embodiment described above, the center electrode 14 projects from the front end 33 of the metal shell 32 toward the front-end side. In contrast, in a spark plug 40 of the third embodiment described below, the center electrode 14 is located on the rear-end side of a front end 43 of a metal shell 42. In the third embodiment, elements that are the same as those described in the first embodiment are denoted by the same reference signs, and the following description is partially omitted.

FIG. 5 is a half sectional view of the spark plug 40 according to the third embodiment. The spark plug 40 includes an insulator 41, the center electrode 14, and the metal shell 42. The distance from the front end 43 of the metal shell 42 to the seating surface 19 is L (mm). A spark gap is provided between a rod-shaped ground electrode 44 connected to the metal shell 42 and the center electrode 14. The main component of the ground electrode 44 is Pt.

FIG. 6 is an enlarged sectional view of a part of the spark plug 40 including the axial line X. A front end 45 of the insulator 41 and the center electrode 14 are located on the rear-end side of the front end 43 of the metal shell 42. A space 46 located inside the inner peripheral surface 20 of the metal shell 42, excluding the center electrode 14 and the insulator 41, and defined by the inner gasket 25 has a capacity V (mm³). The capacity V (mm³), the outer diameter R (mm) of the threaded portion 17, and the distance L (mm) satisfy V/(R²·L)≤0.0170. Thus, the occurrence of pre-ignition can be reduced.

The spark plug 40 is structured such that a portion of the ground electrode 44 is disposed in the space 46. The volume of the portion of the ground electrode 44 in the space 46 is subtracted from the capacity V of the space 46. The capacity V of the space 46 is equal to the volume determined by subtracting an overlapping volume of the ground electrode 44 from the volume of a rotating body obtained by rotating, around the axial line X, an area (mm²) of the space 46 having an outline defined by the inner peripheral surface 20 of the metal shell 42 (including an inner peripheral surface of the inner gasket 25), an outer peripheral surface and the front end 45 of the insulator 41, the center electrode 14, the axial line X, and the perpendicular from the front end 43 of the metal shell 42 to the axial line X. The volume of the ground electrode 44 in the space 46 (overlapping volume of the ground electrode 44) is determined by multiplying the area of a region (quadrangular region) in which the ground electrode 44 and the space 46 overlap in the cross section including the axial line X by the width of the ground electrode 44 (volume of a quadrangular prism).

The outer peripheral surface of the insulator 41 has no projecting portion with a rounded corner having a radius of 1 mm or less in a region 49 that is between an outside corner 47 at the front end 45 of the insulator 41 and an inside corner 48 adjacent to and on the front-end side of the step portion 13, and that faces the inner peripheral surface 20 of the metal shell 42. Since the region 49 has a substantially constant electrical field intensity, the occurrence of side spark between the region 49 and the metal shell 42 can be reduced. Although the region 49 is parallel to the axial line X in the present embodiment, the region 49 is not limited to this. The region 49 may, of course, be at an angle relative to the axial line X or curved.

The spark plug 40 preferably also satisfies 0.0010≤V/(R²·L). In addition, when the area in which the metal shell 42 is in contact with the space 46 is S (mm²), the spark plug 40 preferably satisfies 1.90≤S/V. This is because the occurrence of pre-ignition can be further reduced.

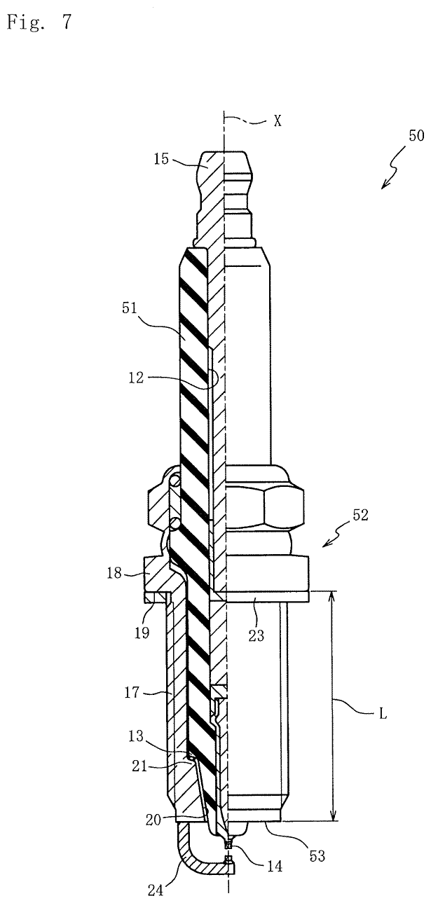

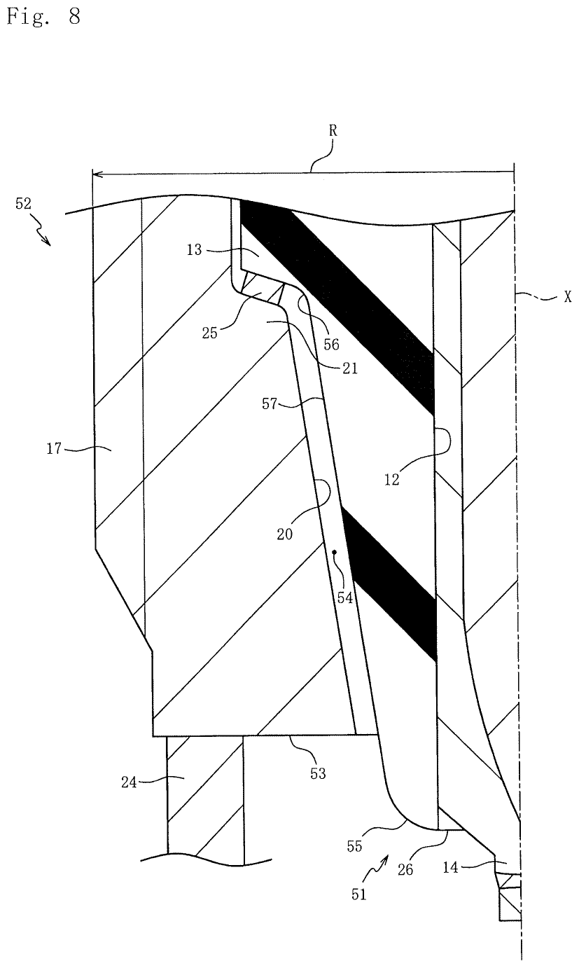

A fourth embodiment will be described with reference to FIGS. 7 and 8. In the spark plug 10 of the first embodiment described above, the insulator 11 has the projecting portion 29a in the region between the outside corner 28 at the front end 26 and the inside corner 29. In contrast, in a spark plug 50 of the fourth embodiment, an insulator 51 has no outside corner in the region between an outside corner 55 at the front end 26 and an inside corner 56. In the fourth embodiment, elements that are the same as those described in the first embodiment are denoted by the same reference signs, and the following description is partially omitted.

FIG. 7 is a half sectional view of the spark plug 50 according to the fourth embodiment. The spark plug 50 includes the insulator 51, the center electrode 14, and a metal shell 52. The distance from a front end 53 of the metal shell 52 to the seating surface 19 is L (mm). A spark gap is provided between a rod-shaped ground electrode 24 connected to the metal shell 52 and the center electrode 14.

FIG. 8 is an enlarged sectional view of a part of the spark plug 50 including the axial line X. The front end 26 of the insulator 51 and the center electrode 14 are located on the front-end side of the front end 53 of the metal shell 52. A space 54 located inside the inner peripheral surface 20 of the metal shell 52, excluding the center electrode 14 and the insulator 51, and defined by the inner gasket 25 has a capacity V (mm³). The capacity V (mm³), the outer diameter R (mm) of the threaded portion 17, and the distance L (mm) satisfy V/(R²·L)≤0.0170 to reduce the occurrence of pre-ignition. The capacity V (mm³) of the space 54 is equal to the volume of a rotating body obtained by rotating, around the axial line X, an area (mm²) of the space 54 having an outline defined by the inner peripheral surface 20 of the metal shell 52 (including an inner peripheral surface of the inner gasket 25), an outer peripheral surface of the insulator 51, and the perpendicular from the front end 53 of the metal shell 52 to the axial line X in the cross section including the axial line X.

The outer peripheral surface of the insulator 51 has no projecting portion with a rounded corner having a radius of 1 mm or less in a region 57 that is between the outside corner 55 at the front end 26 of the insulator 51 and the inside corner 56 adjacent to and on the front-end side of the step portion 13, and that faces the inner peripheral surface 20 of the metal shell 52. Since the region 57 has a substantially constant electrical field intensity, the occurrence of side spark between the region 57 and the metal shell 52 can be reduced. Although the region 57 is at an angle relative to the axial line X in the present embodiment, the region 57 is not limited to this. The region 57 may, of course, be parallel to the axial line X or curved.

The spark plug 50 preferably also satisfies 0.0010≤V/(R²·L). In addition, when the area in which the metal shell 52 is in contact with the space 54 is S (mm²), the spark plug 50 preferably satisfies 1.90≤S/V. This is because the occurrence of pre-ignition can be further reduced.

### EXAMPLE

The present invention will now be described in further detail by way of an example. However, the present invention is not limited to this example.

Samples Nos. 1 to 13 of the spark plug 10 according to the first embodiment were prepared by the tester. The samples differed in the capacity V (mm³) of the space 27, the outer diameter (nominal diameter) R (mm) of the threaded portion 17, the distance L (mm), and the area S (mm²). The tester attached the prepared samples to an inline four-cylinder, naturally aspirated engine with a displacement of 1.3 L, and conducted a test by operating the engine for one minute at an engine revolution of 6000 rpm with a throttle valve set to full throttle and determining whether pre-ignition occurred based on the wave form of ion current. When no pre-ignition occurred in one minute, the ignition timing (crank angle) was advanced by 1°, and the test was similarly performed. The test was repeated until the ignition timing that caused pre-ignition was determined.

The samples were graded A if the ignition timing had been advanced by 4° or more from the regular ignition timing of an OES spark plug for the engine used in the test at the first occurrence of pre-ignition, B if the ignition timing had been advanced by 2° or more and less than 4°, and C if the ignition timing had been advanced by less than 2°.

The distance L (mm) of each sample after the test was measured. The distance L was determined by rounding the digit in the second decimal place. An image of the cross section of the sample after the test including the axial line X was acquired, and the area of the space 27 having an outline defined by the inner peripheral surface 20 of the metal shell 16, the inner peripheral surface of the inner gasket 25, the outer peripheral surface of the insulator 11, and the perpendicular from the front end 22 of the metal shell 16 to the axial line X was determined by picture processing. Then, the area was integrated to determine the volume (capacity V) of the rotating body obtained by rotating the area around the axial line

X. The capacity V was determined by rounding the digit in the second decimal place. In addition, in the cross section of the sample after the test including the axial line X, the distance over which the inner peripheral surface 20 of the metal shell 16 extended between the front end of the inner gasket 25 and the front end 22 of the metal shell 16 was measured, and was integrated to determine the area S of the cylindrical surface obtained by rotation around the axial line X. The area S was determined by rounding the digit in the second decimal place.

Table 1 shows the capacity V (mm³) of the space 27, the outer diameter R (mm) of the threaded portion 17, the distance L (mm), the area S (mm²), V/(R²·L), S/V, and the grade of each of samples Nos. 1 to 13. The outer diameter R is not a value obtained by measuring the outer diameter of the threaded portion 17, but is the nominal diameter specified in a standard, such as JIS. Here, V/(R²·L) was determined by rounding the digit in the fifth decimal place, and S/V was determined by rounding the digit in the third decimal place.

TABLE 1

| | V | R | L | S | | | |
|---|---|---|---|---|---|---|---|
| No. | (mm³) | (mm) | (mm) | (mm²) | V/(R² · L) | S/V | grade |
| 1 | 12.8 | 12 | 26.5 | 72.3 | 0.0034 | 5.65 | A |
| 2 | 22.0 | 10 | 26.5 | 41.8 | 0.0083 | 1.90 | A |
| 3 | 22.0 | 12 | 12.7 | 41.8 | 0.0120 | 1.90 | A |
| 4 | 37.5 | 12 | 19.0 | 72.3 | 0.0137 | 1.93 | A |
| 5 | 54.0 | 12 | 26.5 | 142.4 | 0.0142 | 2.64 | A |
| 6 | 37.5 | 10 | 26.5 | 78.9 | 0.0142 | 2.10 | A |
| 7 | 37.5 | 10 | 26.5 | 68.0 | 0.0142 | 1.81 | B |
| 8 | 45.0 | 10 | 26.5 | 68.0 | 0.0170 | 1.51 | B |
| 9 | 22.0 | 10 | 12.7 | 35.2 | 0.0173 | 1.60 | C |
| 10 | 36.8 | 10 | 19.0 | 85.2 | 0.0194 | 2.32 | C |
| 11 | 37.5 | 10 | 19.0 | 72.3 | 0.0197 | 1.93 | C |
| 12 | 75.5 | 12 | 26.5 | 143.5 | 0.0198 | 1.90 | C |
| 13 | 122.5 | 14 | 26.5 | 152.3 | 0.0236 | 1.24 | C |

As is clear from Table 1, samples Nos. 1 to 8, for which V/(R²·L)≤0.0170, were graded A or B, whereas samples Nos. 9 to 13, for which V/(R²·L)>0.0170, were graded C. In samples Nos. 1 to 8, for which V/(R²·L)≤0.0170, a large amount of heat received by the spark plug 10 from the combustion gas was probably released from the spark plug 10 to the engine through the threaded portion 17, so that pre-ignition did not easily occur.

Among samples Nos. 1 to 8, samples Nos. 1 to 6, for which 1.90≤S/V, were graded A, whereas samples Nos. 7 and 8, for which S/V<1.90, were graded B. For samples Nos. 1 to 6, the combustion gas that had entered the space 27 was probably easily cooled by the metal shell 16, so that heat accumulated in the spark plug 10 was reduced and pre-ignition was less likely to occur.

It has become clear from the example that the occurrence of pre-ignition can be reduced by satisfying V/(R²·L)≤0.0170. In addition, it has also become clear that the occurrence of pre-ignition can be further reduced by satisfying 1.90≤S/V.

Although the present invention has been described based on the embodiments, the present invention is not limited to the above-described embodiments in any way, and it can be easily understood that various improvements and modifications are possible without departing from the spirit of the present invention.

Although the ground electrode 24, 34, 44 is connected to the metal shell 16, 32, 42, 52 in the spark plug 10, 30, 40, 50 according to the embodiments, this does not imply any limitation. The ground electrode 24, 34, 44 may, of course, be omitted so that discharge occurs between the center electrode 14 and the metal shell 16, 32, 42, 52.

Although the inner gasket 25 is interposed between the step portion 13 of the insulator 11, 31, 41, 51 and the metal shell 16, 32, 42, 52, that is, the inner gasket 25 is a part of the retaining portion 21 in the embodiments, this does not imply any limitation. The inner gasket 25 may, of course, be omitted so that the step portion 13 is in direct contact with the retaining portion 21. In this case, a part of the retaining portion 21 that is in direct contact with the step portion 13 defines the space 27, 36, 46, 54.

Although the gasket 23 is disposed between the threaded portion 17 and the seating portion 18 in the embodiments, this does not imply any limitation. The gasket 23 may, of course, be omitted. In addition, the seating surface 19 may be a conical surface (have a conical shape) with a diameter decreasing toward the front-end side in accordance with the shape of the plug hole in the engine (tapered seat). In this case, the distance L between the front end of the metal shell and the seating surface is dimension A specified in JIS B 8031:2006.

### DESCRIPTION OF REFERENCE NUMERALS

10, 30, 40, 50 spark plug
11, 31, 41, 51 insulator
12 axial hole
13 step portion
14 center electrode
16, 32, 42, 52 metal shell
17 threaded portion
18 seating portion
19 seating surface
20 inner peripheral surface
21 retaining portion
22, 33, 43, 53 front end of metal shell
24, 34, 44 ground electrode
26, 35, 45 front end of insulator
27, 36, 46, 54 space
37, 47, 55 outside corner
38, 48, 56 inside corner
39, 49, 57 region
X axial line

What is claimed is:

1. A spark plug comprising:
an insulator having an axial hole extending from a front-end side toward a rear-end side along an axial line, the insulator including a step portion having an outer diameter decreasing from the rear-end side toward the front-end side;
a center electrode disposed in the axial hole; and
a metal shell having a cylindrical shape, the metal shell being disposed around an outer periphery of the insulator and including an inner peripheral surface,
wherein the metal shell includes
a threaded portion including an external thread,
a seating portion including a seating surface provided on the rear-end side of the threaded portion, and
a retaining portion provided on the inner peripheral surface, the retaining portion retaining the step portion, and
wherein the spark plug satisfies V/(R²·L)≤0.0170, where V (mm³) is a capacity of a space that is located on the front-end side of the retaining portion and inside the inner peripheral surface including the retaining portion and that excludes the center electrode and the insulator, R (mm) is an outer diameter of the threaded portion, and L (mm) is a distance from a front end of the metal shell to the seating surface.

2. The spark plug according to claim 1, wherein, in a cross section including the axial line, the insulator has no projecting portion on an outer peripheral surface of the insulator in a region that is between an outside corner at a front end of the insulator and an inside corner adjacent to and on the front-end side of the step portion and that faces the inner peripheral surface of the metal shell.

3. The spark plug according to claim 1, further comprising:
a ground electrode connected to the metal shell,
wherein the ground electrode contains Ni or Pt as a main component.

4. The spark plug according to claim 1, wherein the spark plug satisfies 1.90≤S/V, where S (mm²) is an area in which the metal shell is in contact with the space.
